(19) United States
(12) Patent Application Publication
(10) Pub. No.: US 2007/0140070 A1
(43) Pub. Date: Jun. 21, 2007

(54) Domain expansion read-out for improved domain collapse

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/529,679

(22) PCT Filed: Sep. 12, 2003
(86) PCT No.: PCT/IB03/03944

§ 371 Date: Mar. 29, 2005

(30) Foreign Application Priority Data
Oct. 2, 2002 (EP) 020790903.7

(51) Int. Cl. G11B 11/00

(52) U.S. Cl. 369/13.09

(57) ABSTRACT

Method and apparatus for controlling a read-out operation from a magneto-optical recording medium comprising a storage layer and a read-out layer, wherein a domain is expanded in the read-out layer by copying a mark region from the storage layer to the read-out layer upon heating by a radiation power with the help of a external magnetic field. The radiation power is increased during at least part of the collapse period of said external magnetic field to a first level higher than a second level applied during the expansion period of said external magnetic field. Thereby, the data rate during read-out can be improved due to the fact that the domain collapse speed is enhanced and that delays resulting from slower collapse and non-ideal waveforms of the external magnetic field can be reduced.

The present invention relates to a method and apparatus for controlling read-out from a magneto-optical recording medium, such as a MAMMOS (Magnetic AMplifying Magneto-Optical System) disk, comprising a recording or storage layer and an expansion or read-out layer.

In magneto-optical storage systems, the minimum width of the recorded marks is determined by the diffraction limit, i.e. by the Numerical Aperture (NA) of the focusing lens and the laser wavelength. A reduction of the width is generally based on shorter wavelength lasers and higher NA focusing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of the laser. For read-out of the small crescent-shaped marks recorded in this way, Magnetic Super Resolution (MSR) or Domain Expansion (DomEx) methods have been proposed. These technologies are based on recording media with several magnetostatic or exchange-coupled RE-TM layers. According to MSR, a read-out layer on a magneto-optical disk is arranged to mask adjacent bits during reading, while, according to domain expansion, a domain in the centre of a spot is expanded. The advantage of the domain expansion technique over MSR results in that bits with a length below the diffraction limit can be detected with a similar signal-to-noise ratio (SNR) to that of bits with a size comparable to the diffraction limited spot. MAMMOS is a domain expansion method based on magneto-statically coupled storage and read-out layers, wherein a magnetic field modulation is used for expansion and collapse of expanded domains in the read-out layer.

In the above-mentioned domain expansion techniques, like MAMMOS, a written mark from the storage layer is copied to the read-out layer upon laser heating and with the help of an external magnetic field. Due to the low coercivity of this read-out layer, the copied mark will expand to fill the optical spot and can be detected with a saturated signal level which is independent of the mark size. Reversal of the external magnetic field causes the expanded domain to collapse. A space in the storage layer, on the other hand, will not be copied and no expansion occurs. Therefore, no signal will be detected in this case.

The laser power used in the read-out process should be high enough to enable copying. On the other hand, a higher laser power also increases the overlap of the temperature-induced coercivity profile and the stray field profile of the bit pattern. The coercivity H_{c} decreases and the stray field increases with increasing temperature. When this overlap becomes too large, correct read-out of a space is no longer possible due to false signals generated by neighboring marks. The difference between this maximum and the minimum laser power determines the power margin, which decreases strongly with decreasing bit length.

During MAMMOS read-out, a modulated external magnetic field can be used to control the expansion and collapse of a magnetic domain in the read-out layer at the position of a focused laser beam. Normally, the field is modulated at a constant frequency corresponding to the bit clock with equal field amplitudes for expansion and collapse, but opposite sign. An alternative method of driving the external magnetic field is data-dependent field switching (ddfsw). In this method, the field is kept constant in the expansion direction until a MAMMOS signal is detected. From then on, the field is modulated as in normal read-out, as long as a MAMMOS signal is observed during the expansion period. If no peak is observed, the field again remains in the expansion direction until the next MAMMOS peak. In this way, the field is easily synchronized with the data on the disk. This method also allows improvements in storage density.

Recent measurements of the expansion and collapse speeds have shown that the collapse process is about a factor of three slower than the expansion process and is therefore the most important limiting factor for the ultimate data rate. To increase the collapse speed, it is possible to increase the external magnetic collapse field, but this increases power consumption quite significantly and requires a more complicated coil driver. Moreover, the demands on the coil design will be more stringent due to the fact that a higher field strength is needed and thus more heat is generated.

Ideally, the external field should switch very rapidly and then remain constant at a predetermined positive value until the field is reversed very rapidly. Then, it should remain constant at some predetermined negative value, such as a square waveform, for example. However, coil and driver of the magnetic head are never ideal and may give a field response where, after switching, the field approaches its final value slowly.

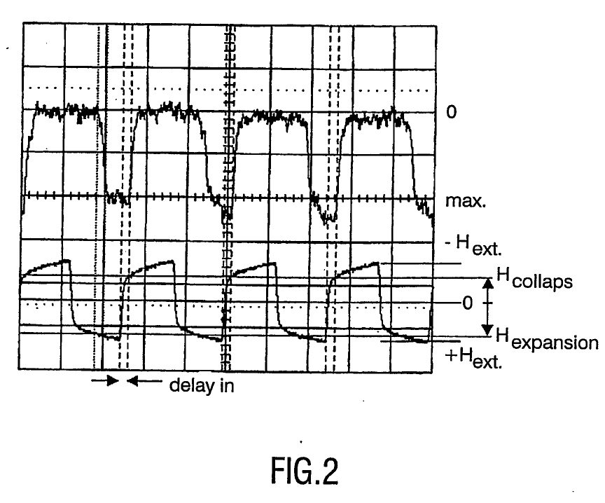

FIG. 2 shows measured waveforms of a MAMMOS signal (upper waveform) with indicated zero and maximum levels, and a corresponding generated external magnetic field (lower waveform) with indicated expansion and collapse directions. As shown in FIG. 2, a delay is caused in the collapse of the domain and thus in the MAMMOS signal. Consequently, the MAMMOS signal starts to disappear only some time after the field has switched to the collapse direction and has reached a certain minimum value. Although this value is still lower than the required expansion field, it is higher than necessary. This is due to the fact that the domain walls are allowed to expand to the relatively cool and high coercivity region of the thermal spot by the slowly increasing expansion field. Therefore, some additional force is needed to un-freeze the domain wall from the local pinning sites. Obviously, the above delay has a negative effect on the achievable data rate.

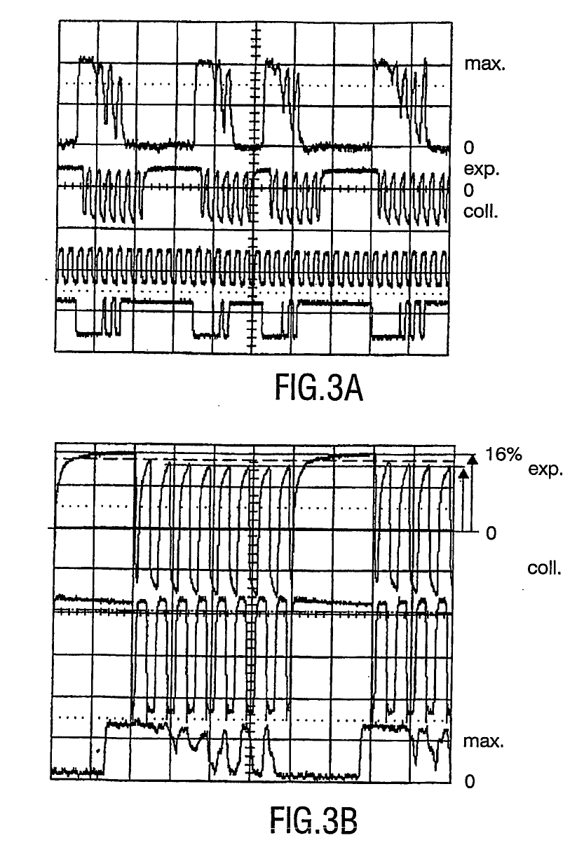

For the ddfsw method, this non-ideal behavior of the generated field causes severe problems, as can be gathered from measured waveforms shown in FIGS. 3A and 3B. In particular, FIG. 3A shows, from top to bottom, waveforms of a MAMMOS signal, a generated external magnetic field, a bit clock, and a sliced version of the MAMMOS signal. FIG. 3B shows, from top to bottom, a waveform of a field current flowing through a coil used for generating the external magnetic field, a digital input signal supplied to the coil driver, and a correspondingly obtained MAMMOS signal. According to FIG. 3B, the end value of the field current or expansion field can easily be 16% greater than the maximum collapse field. This prevents a complete collapse of the expanded domain and causes a number of false MAMMOS signals. To some extent these false peaks can be suppressed by using a DC bias field generated e.g. by a permanent magnet, which is similar to using an asymmetrical external magnetic field with H_{collapse}>Hₑₓₚₐₙₛᵢₒₙ. Neither solution is very practical. Thus, current read-out methods do not work to their full capability with a non-ideal waveform.

It is known from document EP-A-0 951 462, that pulsing the laser on/off at a pulse duty cycle of between 20% and 70% during read-out can be used to improve the read-out performance. For example, it is known that briefly increasing the laser power during the copying period or expansion time strongly enhances the power margin and resolution of the RF-MAMMOS technique. This is not only due to the reduced width of the thermal profile, but mainly due to the reduced (temporal) overlap of the stored bit pattern's stray field with the coercive field profile in the read-out layer.

It is an object of the present invention to provide a method and apparatus for domain expansion read-out control with an improved maximum data rate, even where ddfsw methods are used.

This object is achieved by a method as claimed in claim 1 and by an apparatus as claimed in claim 17.

Accordingly, the maximum data rate during read-out can be improved and/or data dependent field switching is enabled even with a non-ideal coil or driver of the magnetic head. The temporary increase in temperature reduces the coercivity in the read-out layer and will un-freeze the domain wall from the pinning sites and increase the wall mobility. Thus, the maximum data rate can be significantly improved, because the collapse process will start much more easily and will proceed faster and already at a lower collapse field. Experiments on coercivity vs. temperature as well as numerical simulations indicate that a 16% lack of field can be compensated for by an increase in laser power by only a few percent. This means that a relatively simple, symmetrical coil driver may be used, and that a given coil system will give better read-out performance, e.g. higher data rates. Compared with an asymmetrical field driving, this method also has much lower power consumption, i.e. the same expansion field, but much less collapse field is needed. Implementation is straightforward, as only a periodic (bit clock) and small laser pulse is needed which is synchronized with the field modulation (already present). Since only a quite modest temperature increase is sufficient, short laser pulses of limited peak power can be used, so that there are no additional demands on the laser and its driver.

The increasing step may be performed by adding an additional laser pulse of the higher level during at least part of the collapse period. This advantageous further development can easily be implemented because only a periodic and small additional radiation pulse is required, which can be generated by the radiation source and respective driver circuit already present in current systems.

Furthermore, the increasing step may be performed by adding the additional radiation pulse immediately after an expansion laser pulse of the lower radiation power level. Then, the radiation power may be decreased with respect to the expansion level for a predetermined time period immediately after the additional radiation pulse so as to increase the cooling rate and thus the possible data rate for a given stack design of the recording medium.

Additionally, the external magnetic field may be reduced to a stabilizing level after the expansion of the domain. The stabilizing level may be lower than the expansion threshold but high enough to stabilize the expanded domain.

The duty cycle of the additional pulse may be selected to be as great as possible, preferably greater than 70%, e.g. about 100%.

A shorter copy radiation pulse may be applied during the expansion period, while a longer collapse radiation pulse may be applied during the collapse period.

The timing of the second or higher radiation level may be selected such that the thermal decay from a predetermined collapse temperature starts just before the beginning of the expansion period of the external magnetic field.

Furthermore, different spot sizes may be selected during application of the higher and lower levels of radiation power. In particular, a smaller radiation spot size may be used to induce the copy process and a larger radiation spot size may be used during the collapse period. The application of the smaller spot size may start immediately after application of the larger spot size.

An asymmetrical duty cycle switching may be used for applying the external magnetic field, while the timing of the additional pulse relative to the switching of the external magnetic field may correspond to a symmetrical switching.

Alternatively, data-dependent switching is used for applying the external magnetic field, and the additional pulse is applied only after a mark detection. Different spot sizes may then be used during the collapse and expansion periods.

The reading apparatus may be a disk player for MAMMOS disks.

Other advantageous further developments are defined in the dependent claims.

In the following, the present invention will be described on the basis of a preferred embodiment with reference to the accompanying drawings in which:

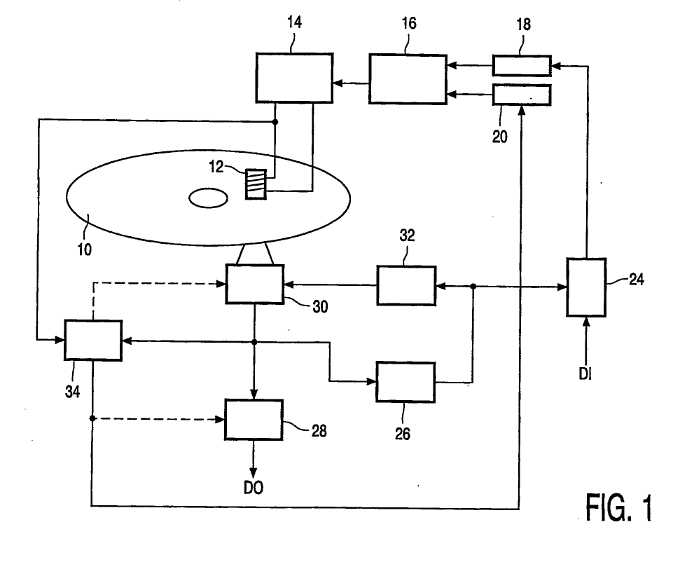

FIG. 1 shows a schematic diagram of a magneto-optical disk player, according to an preferred embodiment,

FIG. 2 shows measured waveforms of a MAMMOS signal and the corresponding external magnetic field,

FIGS. 3A and 3B show measured waveforms indicating a non-ideal behavior of the generated external magnetic field in data-dependent field switching, and

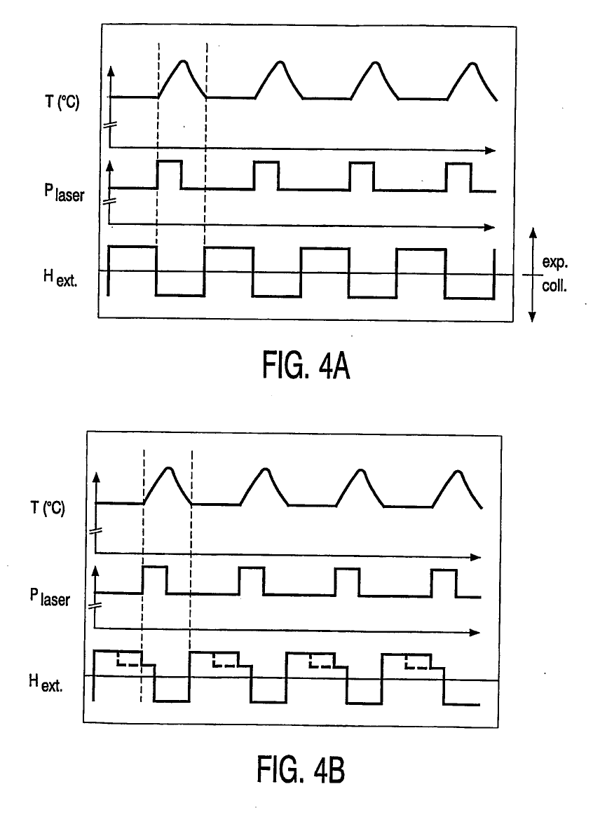

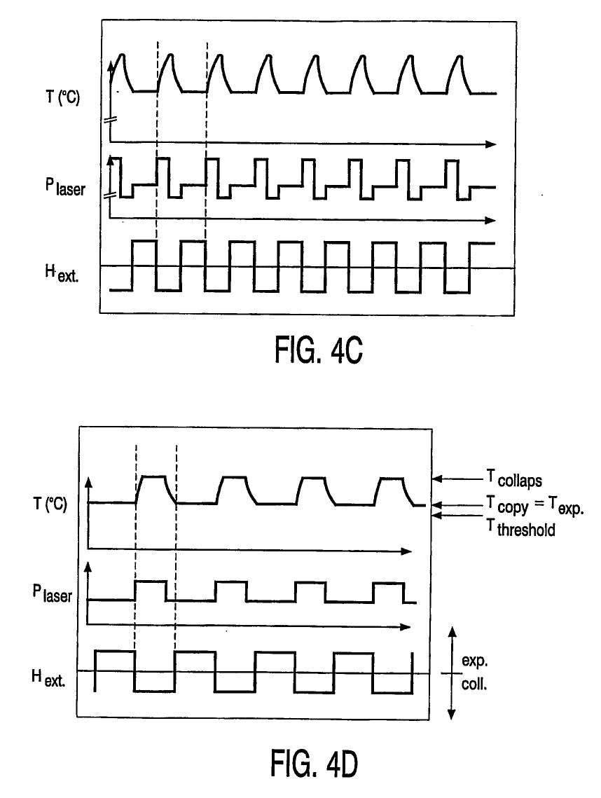

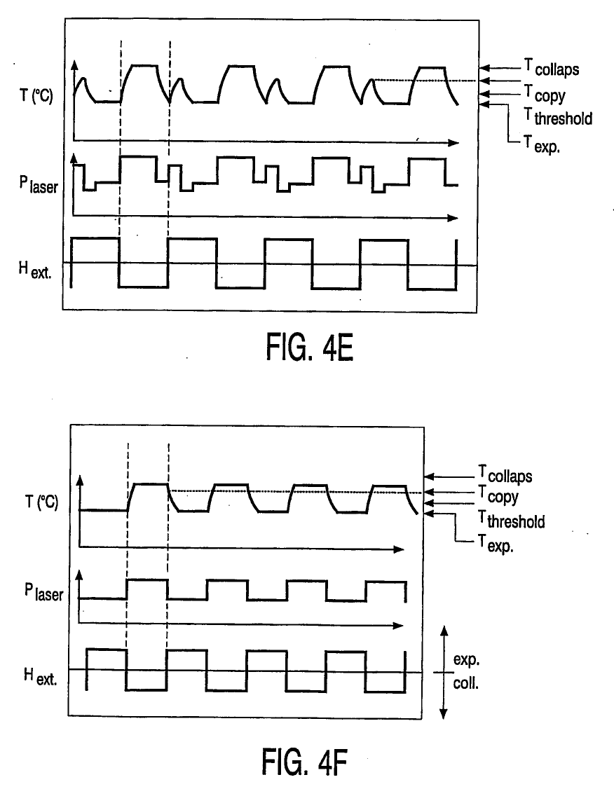

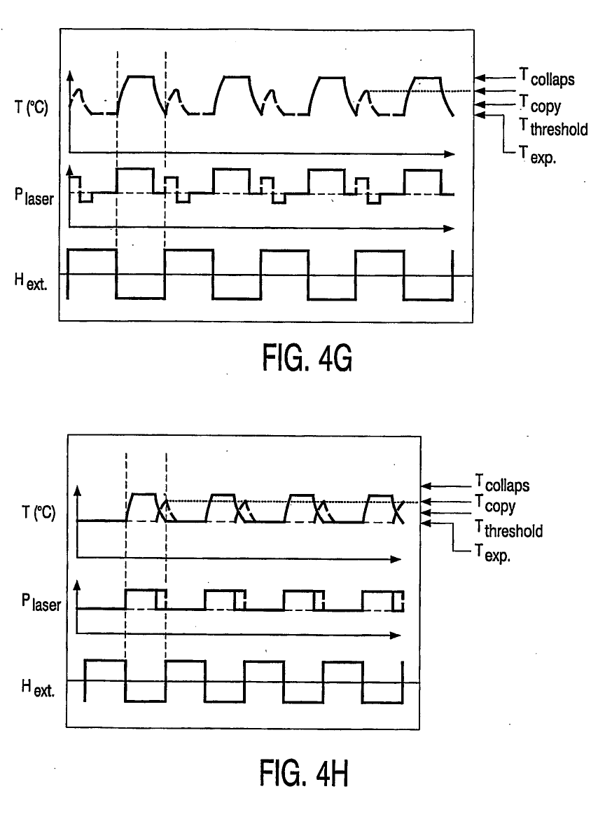

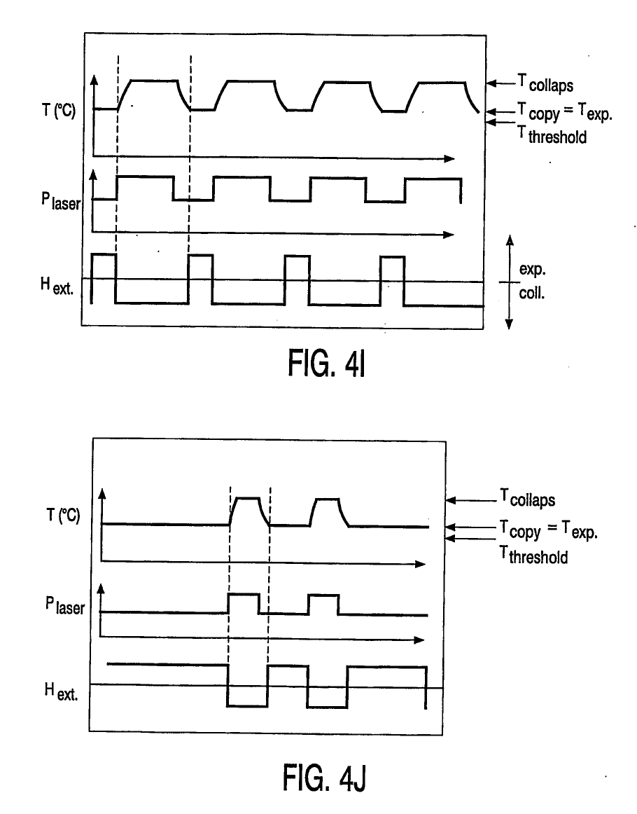

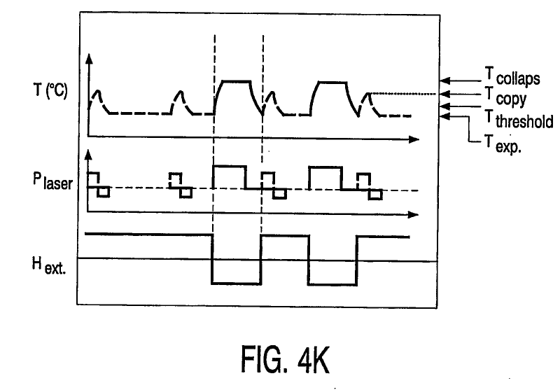

FIGS. 4A to 4K show waveforms of a read-out scheme according to preferred embodiments.

The preferred embodiments will now be described on the basis of a MAMMOS disk player as indicated in FIG. 1.

FIG. 1 schematically shows the construction of the disk player according to the preferred embodiments. The disk player comprises an optical pick-up unit 30 having a laser light radiating section for irradiation of a magneto-optical recording medium or record carrier 10, such as a magneto-optical disk, with light that has been converted, during recording, into pulses with a period synchronized with a code data, and a magnetic field applying section comprising a magnetic head 12 which applies a magnetic field to the magneto-optical disk 10 in a controlled manner at the time of recording and playback. In the optical pick-up unit 30, a laser is connected to a laser driving circuit which receives recording and read-out pulses from a recording/read-out pulse adjusting unit 32 so as to control the pulse amplitude and timing of the laser of the optical pick-up unit 30 during a recording and read-out operation. The recording/read-out pulse adjusting circuit 32 receives a clock signal from a clock generator 26 which may comprise a PLL (Phase Locked Loop) circuit.

It is noted that, for reasons of simplicity, the magnetic head 12 and the optical pickup unit 30 are shown on opposite sides of the disk 10 in FIG. 1. However, according to the preferred embodiment, they should be arranged on the same side of the disk 10.

The magnetic head 12 is connected to a head driver unit 14 and receives, at the time of recording, code-converted data via a phase adjusting circuit 18 from a modulator 24. The modulator 24 converts input recording data into a prescribed code.

At the time of playback, the head driver 14 receives a timing signal via a playback adjusting circuit 20 from a timing circuit 34, said playback adjusting circuit 20 generating a synchronization signal for adjusting the timing and amplitude of pulses applied to the magnetic head 12. The timing circuit 34 may derive its timing signal from the data read-out operation, as described below. Thus, a ddfsw scheme can be achieved. A recording/playback switch 16 is provided for switching or selecting the respective signal to be supplied to the head driver 14 at the time of recording and at the time of playback.

Furthermore, the optical pick-up unit 30 comprises a detector for detecting laser light reflected from the disk 10 and for generating a corresponding reading signal applied to a decoder 28 which is arranged to decode the reading signal for generating output data. Furthermore, the reading signal generated by the optical pick-up unit 30 is supplied to a clock generator 26 in which a clock signal obtained from embossed clock marks of the disk 10 is extracted, and which supplies the clock signal for synchronization purposes to the recording pulse adjusting circuit 32 and the modulator 24. In particular, a data channel clock may be generated in the PLL circuit of the clock generator 26. It is noted that the clock signal obtained from the clock generator 26 may also be supplied to the playback adjusting circuit 20 so as to provide a reference or fallback synchronization which may support the data dependent switching or synchronization controlled by the timing circuit 34.

In the case of data recording, the laser of the optical pick-up unit 30 is modulated with a fixed frequency corresponding to the period of the data channel clock, and the data recording area or spot of the rotating disk 10 is locally heated at equal distances. Additionally, the data channel clock output by the clock generator 26 controls the modulator 24 to generate a data signal with the standard clock period. The recording data are modulated and code-converted by the modulator 24 to obtain a binary run length information corresponding to the information of the recording data.

The structure of the magneto-optical recording medium 10 may correspond to the structure described in JP-A-2000-260079.

In the disk player arrangement shown in FIG. 1, the timing circuit 34 is provided for supplying a data-dependent timing signal t6 the playback adjusting circuit 20. As an alternative, the data-dependent switching of the external magnetic field may equally well be achieved by supplying the timing signal to the head driver 14, so as to adjust the timing or phase of the external magnetic field. The playback adjusting circuit 20 or the head driver 14 are adapted to provide an external magnetic field which is normally in the expansion direction. When a rising signal edge of a MAMMOS peak is observed by the timing circuit 34 at an input line connected to the output of the optical pickup unit 30, the timing signal is supplied to the playback adjusting circuit 20 such that the head driver 14 is controlled to reverse the magnetic field after a short time to collapse the expanded domain in the read-out layer, and shortly after that reset the magnetic field to the expansion direction. The total time between the peak detection and the field reset is set by the timing circuit 34 to correspond to one channel bit length on the disk 10 (times the linear disc velocity).

The data-dependent field switching method mentioned above no longer requires synchronization during read-out, as the switching time is derived directly from the data. Moreover, the derived switching times can be used to further advantage as input for the PLL circuit of the clock generator 26 to provide an accurate data clock. A more precise data recovery based on the space run length information in the time delay can be obtained thereby.

FIGS. 4A to 4K show diagrams indicating (from bottom to top) time-dependent waveform patterns of the external magnetic field, the laser output, and the resulting temperature at the read-out layer.

According to the preferred embodiments, the laser power is increased during at least part of the collapse period of said external magnetic field to a level higher than a lower level applied during the expansion period of the external magnetic field. This has the advantage that the magnetic walls of the expanded domain will temporarily experience a reduced coercivity and will thus start to move more easily and at a higher velocity. This leads to reduced delays and faster collapse times.

In this case, the laser can be pulsed to increase the temperature at least to the copy threshold temperature or the expansion temperature, whichever is the highest, and at least during part of the collapse period. Preferably, the increase in temperature should not start before the expansion field has been sufficiently reduced in amplitude to avoid further expansion of the current domain in the readout layer, or has even been reversed. On the other hand, the increase in temperature can start as soon as possible after reaching the aforementioned field condition; thereby minimizing the delay in collapse and achieving a maximum data rate. Preferably, the temperature increase should be maintained as long as possible to keep the coercivity as low and the wall velocity and related maximum data rate as high as possible.

Eleven embodiments of the present invention will be described below with reference to FIGS. 4A to 4K showing respective waveform patterns which can be used in the playback adjusting circuit 20 for controlling the application of the external magnetic field and in the recording pulse adjusting circuit 32 for controlling the radiation power of the laser or any other suitable radiation source, and the resulting time-dependent behavior of the temperature at the read-out layer. Furthermore, a temperature sensor (not shown in FIG. 1) may be provided for detecting the temperature at the read-out layer so as to obtain a feedback information to be supplied to the playback adjusting circuit 20 and/or the recording pulse adjusting circuit 32. In the diagrams of FIGS. 4A to 4K, the lower waveform pattern corresponds to the external magnetic field Hₑₓₜ, the waveform pattern in the middle corresponds to the laser power Pₗₐₛₑᵣ, and the upper pattern corresponds to the resulting behavior of the temperature T at the read-out layer.

FIG. 4A shows waveform patterns of the first preferred embodiment. To prevent a decrease in resolution or power margin, the temperature in the read-out layer should be back at the steady-state temperature Tₑₓₚ before the expansion field starts. Thus, the duration and radiation power of the collapse radiation pulse is selected correspondingly. This will also prevent the next copied domain from expanding too far.

FIG. 4B shows waveform patterns of the second preferred embodiment. Here, a stabilizing external magnetic field smaller than the expansion threshold is temporarily applied during the expansion period. The corresponding control functionality maybe implemented in the playback adjusting circuit 20. The strength and/or duration of the stabilizing field is selected to be large enough to stabilize the expanded domain.

FIG. 4C shows waveform patterns of the third preferred embodiment. To increase the cooling rate and thus the achievable data rate for a given disk stack design, the laser power is decreased briefly by a predetermined amount for a predetermined time period, immediately after the collapse pulse of the laser.

Various modifications/versions of the second and third embodiments may be used to improve the data rate if the thermal response of the disk is limiting, i.e. to start earlier with the pulse at a sufficiently reduced magnetic field (second embodiment) and/or to reduce the laser power immediately after the pulse to increase the cooling rate (third embodiment).

FIG. 4D shows waveform patterns of the fourth preferred embodiment similar to the first preferred embodiment, where the copy temperature T_{copy} is always reduced back to the steady state temperature Tₑₓₚ (T_{copy}=Tₑₓₚ) before the next expansion period starts, i.e. before the field has been reversed to the expansion direction. However, here the collapse pulse can be selected to be as long as possible, e.g. with a duty cycle of about 100% with respect to the collapse period. The steady-state temperature must be at least somewhat higher than the copy threshold temperature T_{threshold} so as to enable the copy/expansion readout process. However, a value that is too high increases the copy window to an unacceptable size and will lead to a reduction in resolution. In that case it is also possible that the domains will expand too far, to the cooler, high-coercivity regions of the readout layer, thus counteracting the proposed improved collapse process. This situation can be used for conventional field switching, including other measures like reduced expansion field duty cycle and stabilizing fields.

It is even more advantageous to combine it with a known pulsed read-out in the expansion period. The copy threshold temperature T_{threshold} (T_{copy}>T_{threshold}) determines the copy window size. The collapse temperature T_{collapse} is increased by the additional collapse pulse (T_{copy}=Tₑₓₚ<T_{collapse}), and a long duration of the high collapse temperature T_{collapse} results in the highest collapse rate and the highest data rate. Resolution or margin remains unchanged.

FIG. 4E shows waveform patterns of the fifth preferred embodiment. Here, a direct combination of a short copy pulse during the expansion period and a longer pulse during the collapse period is applied, resulting in added advantages. For an improved collapse, the collapse temperature T_{collapse} should at least be higher than the copy threshold temperature T_{threshold}, which has to be higher than the expansion temperature Tₑₓₚ in this case, and preferably the collapse temperature should be selected to be higher than or equal to the copy temperature (T_{collapse}≧T_{copy}) or even more preferably higher than the copy temperature (T_{collapse}>T_{copy}).

FIG. 4F shows waveform patterns of the sixth preferred embodiment. To obtain an increased resolution, it is required that the expansion temperature is lower than the copy threshold temperature T_{threshold} (Tₑₓₚ<T_{threshold}<T_{copy}), while for improved collapse the collapse temperature should be higher than or equal to the copy temperature (Tₑₓₚ≦T_{copy}≦T_{collapse}). These conditions can also be met by using a much simpler laser waveform, which does not require very short pulses. The thermal decay from the collapse temperature T_{collapse} should start just before the field reversal to the expansion direction, thus reaching the copy temperature T_{copy} at the beginning of the expansion period. Further cooling down to the expansion temperature Tₑₓₚ<T_{threshold} ensures not only the improved collapse but also the same resolution improvement as in the fifth preferred embodiment. Additional advantages are a much simpler waveform, a simpler/cheaper laser and driver, a simple implementation, and a higher possible data rate.

FIG. 4G shows waveform patterns of the seventh preferred embodiment. This embodiment relates to an implementation of the fifth preferred embodiment with two different laser spot sizes. Improved collapse is determined mainly by the temperature near the edge of the expanded domain, so that it is beneficial to use the largest spot of the laser beam to improve the collapse period in the ways described above. This spot is also preferably used for signal detection, and its power should preferably be kept constant as much as possible during the expansion period, which is advantageous for simple read-out. For enhancing the resolution, the temperature distribution in the center of the spot is essential, so that the smallest spot is best used for inducing the copy process (dashed line of the laser power waveform) and also for tracking to allow the highest track density. What is new compared with the prior art is the collapse improving laser pulsing on the collapse period with the larger spot.

FIG. 4H shows waveform patterns of the eighth preferred embodiment. This embodiment corresponds to a variation of the seventh preferred embodiment with a different timing and is similar to the sixth embodiment in its simplicity of waveforms. Here, a laser pulse with a small spot size (dashed line of the laser power waveform) may start earlier than drawn to get same thermal response with less short pulses.

FIG. 4I shows waveform patterns of the ninth preferred embodiment. According to the ninth preferred embodiment, a known asymmetrical duty cycle field switching with a shorter expansion period is used for switching the external magnetic field. This may also be applied for switching with a reduced stabilizing field. The timing of the collapse improving laser pulsing during the collapse period, relative to the switching of the external field, is basically the same as for the above symmetrical field switching. However, now the collapse pulse can be made longer due to the longer expansion period.

FIG. 4J shows waveform patterns of the tenth preferred embodiment in which a data-dependent field switching is used for switching the external magnetic field. In this field switching method, the external magnetic field is kept in the expansion direction until a mark is detected. To avoid a decreased resolution or false peaks, the collapse laser pulse should be avoided during this time. Thus, the collapse improving laser pulsing should only be applied when the field is switched to the collapse direction, i.e. after mark detection and not at each bit period as in the previous cases.

FIG. 4K shows waveform patterns of the eleventh preferred embodiment. This embodiment is similar to the tenth preferred embodiment, but with two different spot sizes of the laser beam for additional resolution improvement. In this case, a resolution improving copy pulsing (dashed line of laser power waveform) should be applied at every bit period, while the collapse improving pulsing (solid line of laser power waveform) should only be applied when the external magnetic field is switched to the collapse direction.

The present invention can be applied to any reading system for domain expansion magneto-optical disk storage systems. Moreover, the above preferred embodiments may be modified by any suitable combination of the features thereof. Any waveform pattern of the external magnetic field and the radiation power can be implemented so as to achieve at least a temporary increase of the radiation power level during the collapse period of the external magnetic field. The preferred embodiments may thus vary within the scope of the attached claims.

1. A method of controlling a read-out operation from a magneto-optical recording medium (10), said recording medium comprising a storage layer and a read-out layer, wherein a domain is expanded in said read-out layer by copying a mark region from said storage layer to said read-out layer upon heating by a radiation beam having a radiation power and with the help of an external magnetic field, said method comprising the steps of: modulating said external magnetic field to control the expansion of said domain during an expansion period and to control the collapse of said domain during a collapse period; and
increasing said radiation power during at least part of said collapse period of said external magnetic field to a first level, said first level being higher than a second level applied during said expansion period of said external magnetic field.

2. A method according to claim 1, wherein said increasing of said radiation power is obtained by adding an additional radiation pulse during said part of said collapse period.

3. A method according to claim 2, wherein said increasing of said radiation power is obtained by adding said additional radiation pulse immediately after an expansion radiation pulse of said second level.

4. A method according to claim 2, wherein the duty cycle of said additional pulse is greater than 70%.

5. A method according to claim 4, wherein the duty cycle of said higher level is about 100%.

6. A method according to claim 2, wherein said radiation power is decreased with respect to said second level for a predetermined time period immediately after said additional radiation pulse.

7. A method according to claim 1, wherein said external magnetic field is reduced to a stabilizing level after the expansion of said domain.

8. A method according to claim 1, wherein a first radiation pulse is applied during said expansion period and a second radiation pulse is applied during said collapse period, said first radiation pulse being shorter than said second radiation pulse.

9. A method according to claim 1, wherein the timing of the application of said first level is selected such that the thermal decay from a predetermined collapse temperature starts just before the beginning of said expansion period of said external magnetic field.

10. A method according to claim 1, wherein the radiation spot size selected during the application of said first level of radiation power differs from the radiation spot size selected during the application of said second level of radiation power.

11. A method according to claim 10, wherein a smaller spot size is used to induce the copy process and a larger spot size is used during said collapse period.

12. A method according to claim 11, wherein the application of said smaller spot size starts immediately after the application of said larger spot size.

13. A method according to claim 2, wherein an asymmetrical duty cycle switching is used for applying said external magnetic field, while the timing of said additional pulse relative to the switching of said external magnetic field corresponds to a symmetrical switching.

14. A method according to claim 2, wherein a data-dependent switching is used for applying said external magnetic field, and wherein said additional pulse is applied only after a mark detection.

15. A method according to claim 14, wherein a radiation spot size used during said collapse period differs from a radiation spot size used during said expansion period.

16. A method according to claim 1, wherein said increasing of said radiation power is performed such that the temperature of said read-out layer during said collapse period is higher than or equal to the temperature of said read-out layer during said expansion period.

17. A reading apparatus for controlling a read-out operation from a magneto-optical recording medium (10) comprising a storage layer and a read-out layer, wherein a domain is expanded in said read-out layer by copying a mark region from said storage layer to said read-out layer upon heating by a radiation power with the help of an external magnetic field, said apparatus comprising:
a) modulating means (20) for modulating said external magnetic field so as to control the expansion of said domain during an expansion period and to control the collapse of said domain during a collapse period; and
b) power control means (32) for increasing said radiation power during at least part of said collapse period of said external magnetic field to a first level, said first level being higher than a second level applied during said expansion period of said external magnetic field.

18. An apparatus according to claim 17, wherein said reading apparatus is a disk player for MAMMOS disks.

19. An apparatus according to claim 17, wherein said power control means (32) is adapted to increase said radiation power by adding an additional radiation pulse during said part of said collapse period.

20. An apparatus according to claim 17, wherein said modulating means (20) is adapted to reduce said external magnetic field to a stabilizing level after the expansion of said domain.

21. An apparatus according to claim 17, wherein said power control means (32) is adapted to apply a first radiation pulse during said expansion period and a second radiation pulse during said collapse period, said first radiation pulse being shorter than said second radiation pulse.

22. An apparatus according to claim 17, wherein said power control means (32) is adapted to select the timing of the application of said second level such that the thermal decay from a predetermined collapse temperature starts just before the beginning of said expansion period of said external magnetic field.

23. An apparatus according to claim 17, wherein said apparatus is adapted to select a radiation spot size during the application of said first level of radiation power which differs from the radiation spot size selected during the application of said second level of radiation power.

24. An apparatus according to claim 17, wherein said power control means (32) is adapted to increase said radiation power such that the temperature of said read-out layer during said collapse period is higher than or equal to the temperature of said read-out layer during said expansion period.
